(19) United States
(12) Patent Application Publication
(10) Pub. No.: US 2026/0349481 A1
(43) Pub. Date: Nov. 5, 2026

(54) SYSTEMS AND METHODS FOR CONNECTING CIRCUIT BOARDS OF AN IHS

(71) Applicant: Dell Products L.P., Round Rock, TX (US)

(72) Inventors: Arnold Thomas Schnell, Hutto, TX (US); Jonathan Isom, Austin, TX (US); Ernesto Ramirez, Austin, TX (US)

(73) Assignee: Dell Products L.P., Round Rock, TX (US)

(21) Appl. No.: 19/198,611

(22) Filed: May 5, 2025

(51) Int. Cl. G06F 1/185; H01R 12/70

(52) U.S. Cl. CPC G06F 1/185; H01R 12/7047

(57) ABSTRACT

An information handling system (IHS) includes a first circuit board and a second circuit board, which are electrically and physically coupled by a board connecting system. The board connecting system has a first array of surface contact connections that has a chamfered rectangular shape and a mounting opening surrounded by the surface contact connections. Some contact locations are strategically omitted to optimize signal routing through the array.

### FIELD

The present description relates generally to information handling devices (IHSs) and, more specifically, to systems and method for connecting circuit boards of an IHS.

### BACKGROUND

As the value and use of information continue to increase, individuals and businesses seek additional ways to process and store it. One option available to users is an Information Handling System (IHS). An IHS generally processes, compiles, stores, and/or communicates information or data for business, personal, or other purposes thereby allowing users to take advantage of the value of the information.

Because technology and information handling needs and requirements vary between different users or applications, IHSs may also vary regarding what information is handled, how the information is handled, how much information is processed, stored, or communicated, and how quickly and efficiently the information may be processed, stored, or communicated.

Variations in IHSs allow for IHSs to be general or configured for a specific user or specific use, such as financial transaction processing, airline reservations, enterprise data storage, or global communications. In addition, IHSs may include a variety of hardware and software components that may be configured to process, store, and communicate information and may include one or more computer systems, data storage systems, and networking systems.

### SUMMARY

According to one embodiment, an information handling system (IHS) includes: a first circuit board having a first electronic component disposed thereon; a second circuit board having a second electronic component disposed thereon; and a board connecting system providing electrical coupling from the first circuit board to the second circuit board, including providing electrical communication between the first electronic component and the second electronic component, wherein the board connecting system includes a first array of surface contact connections on the first circuit board, wherein the first array of surface contact connections has a first portion arranged as a chamfered rectangular shape and a mounting opening surrounded by a first set of the surface contact connections.

According to one embodiment, an information handling system (IHS) includes: a system on-chip (SoC); a first circuit board, upon which the SoC is disposed; a board connector arranged at a first edge of the first circuit board, wherein the board connector comprises a first array of surface contact connections, each surface contact connection of the first array being electrically coupled to a respective conductor within the first circuit board, further wherein the first array of surface contact connections has a first portion that is a chamfered rectangular shape and a second portion that is a convex shape and adjacent the first portion, further wherein the first array includes a mounting hole that is surrounded by a subset of the surface contact connections.

According to one embodiment, a method includes: installing a first circuit board and a second circuit board into a housing of an information handling system (IHS); electrically coupling a first electronic component of the IHS to a second electronic component of the IHS by coupling the first circuit board, having the first electronic component, to the second circuit board, having the second electronic component using a board connecting system, wherein the board connecting system includes a first array of surface contact connections on the first circuit board, wherein the first array of surface contact connections has a first portion arranged as a chamfered rectangular shape and a mounting opening surrounded by a first set of the surface contact connections.

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a block diagram of components of an example IHS, which may be adapted for use with various board connecting systems, according to some embodiments.

FIG. 2 is an illustration of an example IHS, adapted according to some embodiments.

FIG. 3 is an illustration of an example system, adapted according to some embodiments.

FIG. 4 is an illustration of an example system, adapted according to some embodiments.

FIG. 5 is an illustration of example arrays of surface contact connections, according to some embodiments.

FIG. 6 is an illustration of example arrays of surface contact connections, according to various embodiments.

FIG. 7 shows example arrays of surface contact connections, according to some embodiments.

FIG. 8 is another illustration of the example array of FIG. 6, according to some embodiments.

FIGS. 9-10 illustrate a board connecting system, including example circuit boards, such as may correspond to example boards of FIG. 2 and FIG. 4, according to some embodiments.

FIG. 11 is an illustration of an example method, according to some embodiments, for manufacturing an IHS.

### DETAILED DESCRIPTION

For purposes of this disclosure, an Information Handling System (IHS) may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smartphone), server (e.g., blade server or rack server), a network storage device, or any other suitable device and may vary in size, shape, performance, functionality, and price.

An IHS may include Random Access Memory (RAM), one or more processing resources such as a Central Processing Unit (CPU) or hardware or software control logic, Read-Only Memory (ROM), and/or other types of nonvolatile memory. Additional components of an IHS may include one or more disk drives, one or more network ports for communicating with external devices as well as various I/O devices, such as a keyboard, a mouse, a touchscreen, and/or a video display. An IHS may also include one or more buses operable to transmit communications between the various hardware components.

As used herein, the terms “heterogenous computing platform,” “heterogenous processor,” or “heterogenous platform,” and other like terms, as used herein, generally refer to various types of Integrated Circuit (ICs) or chips (e.g., a System-On-Chip or “SoC,” a Field-Programmable Gate Array or “FPGA,” an Application-Specific Integrated Circuit or “ASIC,” etc.) containing a plurality of discrete processing circuits or semiconductor Intellectual Property (IP) cores (collectively referred to as “SoC devices” or simply “devices”) in a single electronic or semiconductor package, where each device may have different processing capabilities suitable for handling a corresponding type of computational task. Examples of heterogeneous processors include, but are not limited to: QUALCOMM's SNAPDRAGON, SAMSUNG's EXYNOS, APPLE's “A” SERIES, etc.

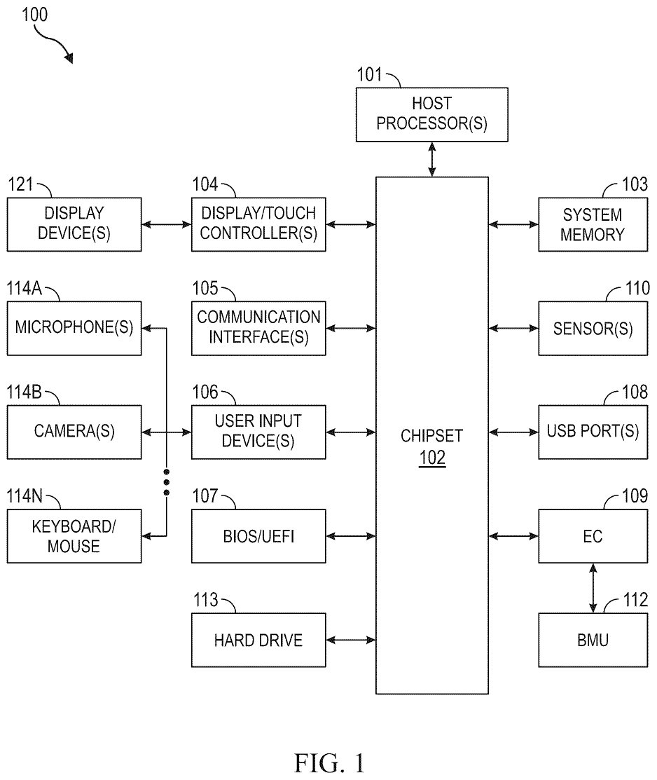

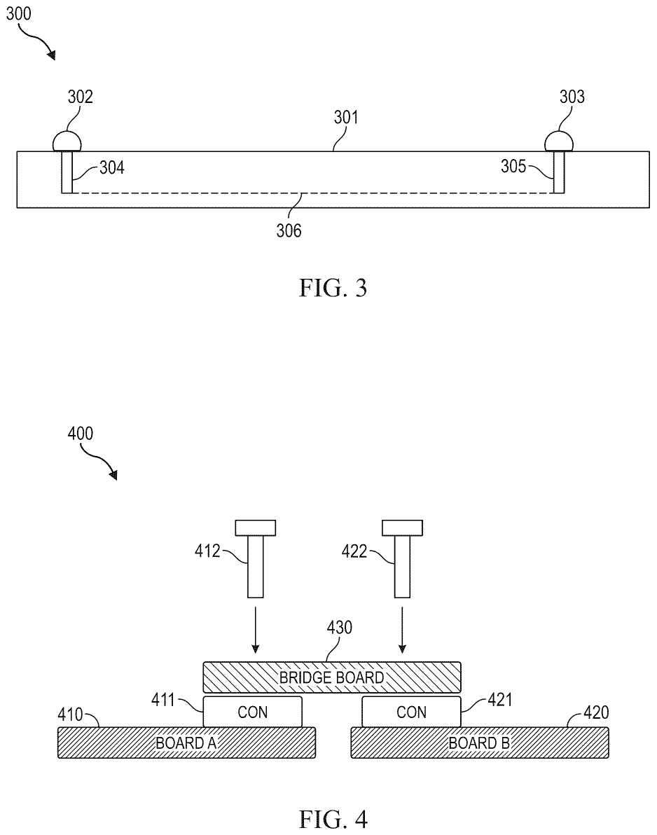

FIG. 1 is a block diagram of components of IHS 100, which may be adapted for use with various board connecting systems, such as those described with respect to FIGS. 3-10. In various embodiments, IHS 100 may be used to implement any appropriate IHS type, such as a laptop computer, server computer, conference room video bar, tablet computer, and/or the like. As depicted, IHS 100 includes host processor(s) 101.

IHS 100 may be a single-processor system or a multi-processor system including two or more processors. Host processor(s) 101 may include any processor capable of executing program instructions, such as an INTEL/AMD x86 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 100 includes chipset 102 coupled to host processor(s) 101. Chipset 102 may provide host processor(s) 101 with access to several resources. In some cases, chipset 102 may utilize a QuickPath Interconnect (QPI) bus to communicate with host processor(s) 101. Chipset 102 may also be coupled to communication interface(s) 105 to enable communications between IHS 100 and various wired and/or wireless devices or networks, such as Ethernet, WiFi, BLUETOOTH (BT), BT Low-Energy (BLE), cellular or mobile networks (e.g., Code-Division Multiple Access or “CDMA,” Time-Division Multiple Access or “TDMA,” Long-Term Evolution or “LTE,” etc.), satellite networks, or the like.

Communication interface(s) 105 may be used to communicate with peripherals devices (e.g., BT speakers, microphones, headsets, etc.). Moreover, communication interface(s) 105 may be coupled to chipset 102 via a Peripheral Component Interconnect Express (PCIe) bus, or the like.

Chipset 102 may be coupled to display and/or touchscreen controller(s) 104, which may include one or more or Graphics Processor Units (GPUs) on a graphics bus, such as an Accelerated Graphics Port (AGP) or PCIe bus. As shown, display controller(s) 104 provide video or display signals to one or more display device(s) 111.

Display device(s) 111 may include Liquid Crystal Display (LCD), light-emitting diode (LED), organic LED (OLED), or other thin film display technologies. Display device(s) 111 may include a plurality of pixels arranged in a matrix, configured to display visual information, such as text, two-dimensional images, video, three-dimensional images, etc. In some cases, display device(s) 111 may be provided as a single continuous display, rather than two discrete displays.

Chipset 102 may provide host processor(s) 101 and/or display controller(s) 104 with access to system memory 103. In various implementations, system memory 103 may be implemented using any other suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 102 may also provide host processor(s) 101 with access to one or more Universal Serial Bus (USB) ports 108, to which one or more peripheral devices may be coupled (e.g., integrated or external webcams, microphones, speakers, etc.).

Chipset 102 may further provide host processor(s) 101 with access to one or more hard disk drives, solid-state drives, optical drives, or other removable-media drives 113.

Chipset 102 may also provide access to one or more user input devices 106, for example, using a super I/O controller or the like. Examples of user input devices 106 include, but are not limited to, microphone(s) 114A, camera(s) 114B, and keyboard/mouse 114N. Other user input devices 106 may include a touchpad, stylus or active pen, totem, etc. Each of user input devices 106 may include a respective controller (e.g., a touchpad may have its own touchpad controller) that interfaces with chipset 102 through a wired or wireless connection (e.g., via communication interfaces(s) 105). In some cases, chipset 102 may also provide access to one or more user output devices (e.g., video projectors, paper printers, 3D printers, loudspeakers, audio headsets, Virtual/Augmented Reality (VR/AR) devices, etc.).

In certain implementations, chipset 102 may provide an interface for communications with one or more hardware sensors 120. Sensors 120 may be disposed on or within the chassis of IHS 100, or otherwise coupled to IHS 100, and may include, but are not limited to, electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

BIOS 107 is coupled to chipset 102. UEFI was designed as a successor to BIOS, and many modern IHSs utilize UEFI in addition to or instead of the BIOS. Accordingly, BIOS/UEFI 107 is intended to also encompass corresponding UEFI component(s). BIOS/UEFI 107 provides an abstraction layer that allows the OS to interface with certain hardware components that are utilized by IHS 100.

Upon booting of IHS 100, host processor(s) 101 may utilize program instructions of BIOS 107 to initialize and test hardware components coupled to IHS 100, and to load host OS for use by IHS 100. Via the hardware abstraction layer provided by BIOS/UEFI 107, software stored in system memory 103 and executed by host processor(s) 101 can interface with certain I/O devices that are coupled to IHS 100.

Embedded Controller (EC) 109 (sometimes referred to as a Baseboard Management Controller or “BMC”) includes a microcontroller unit or processing core dedicated to handling selected IHS operations not ordinarily handled by host processor(s) 101. Examples of such operations may include, but are not limited to, power sequencing, power management, receiving and processing signals from a keyboard or touchpad, as well as other buttons and switches (e.g., power button, laptop lid switch, etc.), receiving and processing thermal measurements (e.g., performing cooling fan control, CPU and GPU throttling, and emergency shutdown), controlling indicator Light-Emitting Diodes or “LEDs” (e.g., caps lock, scroll lock, num lock, battery, ac, power, wireless LAN, sleep, etc.), managing the battery charger and the battery, enabling remote management, diagnostics, and remediation over network(s) 103, etc.

Unlike other devices in IHS 100, EC 109 may be made operational from the very start of each power reset, before other devices are fully running or powered on. As such, EC 109 may be responsible for interfacing with a power adapter to manage the power consumption of IHS 100. These operations may be utilized to determine the power status of IHS 100, such as whether IHS 100 is operating from battery power or is plugged into an AC power source. Firmware instructions utilized by EC 109 may be used to manage other core operations of IHS 100 (e.g., turbo modes, maximum operating clock frequencies of certain components, etc.).

In addition, EC 109 may provide an out of band (OOB) channel that allows an Information Technology Decision Maker (ITDM) or Original Equipment Manufacturer (OEM) to manage IHS 100's various settings and configurations, for example, by issuing Out-of-Band (OOB) commands.

In various embodiments, IHS 100 may be coupled to an external power source through an AC adapter, power brick, or the like. The AC adapter may be removably coupled to a battery charge controller to provide IHS 100 with a source of DC power provided by battery cells of a battery system in the form of a battery pack (e.g., a lithium-ion or “Li-ion” battery pack, or a nickel metal hydride or “NiMH” battery pack including one or more rechargeable batteries).

Battery Management Unit (BMU) 112 may be coupled to EC 109 and it may include, for example, an Analog Front End (AFE), storage (e.g., non-volatile memory), and a microcontroller. In some cases, BMU 112 may be configured to collect and store information, and to provide that information to other IHS components, such as for example, devices within heterogeneous computing platform 300 (FIG. 3).

Examples of information collectible by BMU 112 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information (e.g., such as ambient temperature, relative humidity, system geolocation measured by GPS or triangulation, time and date, etc.), events, etc.

In some embodiments, IHS 100 may not include all the components shown in FIG. 1. In other embodiments, IHS 100 may include other components in addition to those that are shown in FIG. 1. Furthermore, some components that are represented as separate components in FIG. 1 may instead be integrated with other components, such that all or a portion of the operations executed by the illustrated components may instead be executed by the integrated component.

As such, IHS 100 may assume different form factors including, but not limited to: servers, workstations, desktops, laptops, appliances, video game consoles, tablets, smartphones, video bars, etc.

The various components 101-121 may be implemented by being mounted upon one or more circuit boards. Examples of circuit boards may include, e.g., printed circuit boards (PCBs). Examples of PCBs may include a multitude of insulating layers with conductive layers disposed therebetween. In one example PCB, the insulating layers may include FR-4 glass epoxy, and the conductive layers may include copper, though the scope of embodiments is not limited to any particular materials.

In one example of IHS 100, electronic components (e.g., host processors 101, system memory 103, and chipset 102) may be mounted on a first circuit board, where that circuit board provides electrical coupling between external pins of the electronic components and conductive traces within the first circuit board. Similarly, other electronic components (e.g., USB ports 108, hard drive 113, and communication interfaces 105) may be mounted on a second circuit board, where that second circuit board provides electrical coupling from external pins of the electronic components to conductive traces within the second circuit board. The first and second circuit boards may be designed to fit within a form factor, such as a laptop computer form factor, tablet computer form factor, and/or the like.

In some embodiments, the first circuit board and the second circuit board may be electrically coupled using one or more circuit board connecting systems so that the electronic components on the first circuit board may communicate with the electronic components on the second circuit board. Furthermore, a board connecting system may provide conductive paths for other resources, such as power resources.

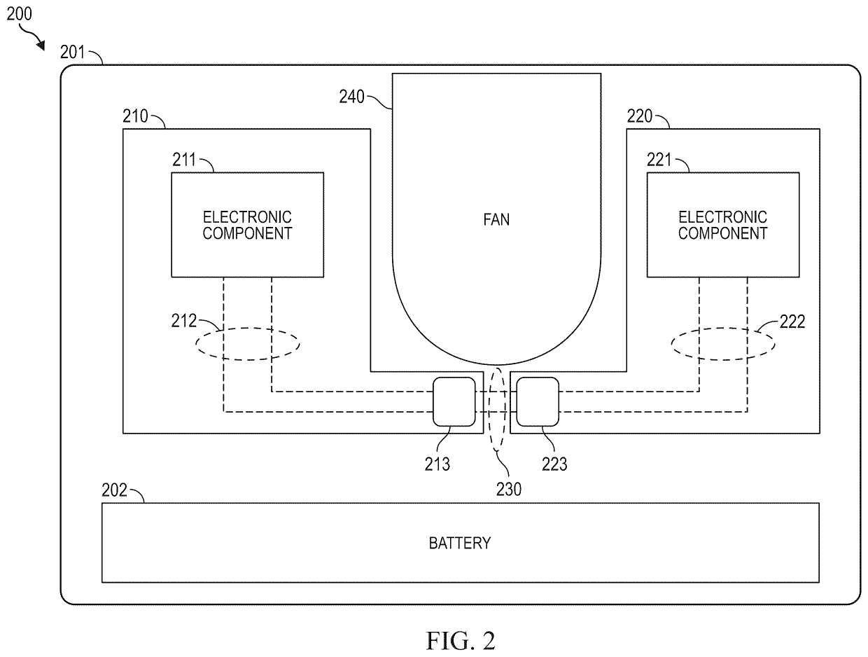

FIG. 2 is an illustration of an example IHS 200, adapted according to some embodiments. In the example of FIG. 2, the IHS 200 may be configured as a laptop computer, though, as mentioned above, the scope of implementations may include any appropriate form factor.

FIG. 2 shows a top-down view, and it is a simplified illustration of a laptop computer form factor. For instance, FIG. 2 omits showing a fold-down screen or a keyboard and, rather, illustrates internal components within housing 201. Housing 201 may be implemented using any appropriate material, such as metal or plastic. Within housing 201 are battery 202, circuit board 210, circuit board 220, and fan 240.

Battery 202 may include any appropriate battery, such as a lithium-ion battery or other battery technology. Battery 202 may provide power for operation of the IHS 200, such as by supplying power to electronic components 211, electronic components 221, fan 240, display screen (not shown), and/or the like. Fan 240 may be any appropriate fan or other cooling system to provide cooling to the IHS 200. For instance, fan 240 may be implemented as an air-blowing fan, which moves hot air from inside the housing 201 to outside housing 201.

Electronic component 211 is mounted to circuit board 210. For instance, electronic component 211 may include one or more external pins, which are electronically coupled to electrical contacts on a surface of circuit board 210. The electrical contacts may provide electrical coupling from the electronic component 211 to the conductive traces 212. FIG. 2 shows two conductive traces 212 for ease of illustration, and it is understood that circuit board 210 may provide any appropriate quantity of conductive traces to carry signals, data, and/or power to and from the electronic components 211. Furthermore, the conductive traces 212 may be in a same layer or a multitude of different layers within circuit board 210.

Electronic component 221 is similarly mounted to circuit board 220 as described above for electronic component 211 and circuit board 210. Circuit board 220 provides conductive traces 222 to carry signals, data, and/or power to and from the electronic components 221. As with the example of circuit board 210, the conductive traces 222 may include any appropriate quantity of conductive traces and may be in a same layer or a multitude of different layers of circuit board 220.

Conductive traces 212 provide electrical communication between the electronic component 211 and a first array 213 of surface contact connections. Similarly, conductive traces 222 provide electrical communication between the electronic component 221 and a second array 223 of surface contact connections. Arrays of surface contact connections are described in more detail with respect to FIGS. 3-10.

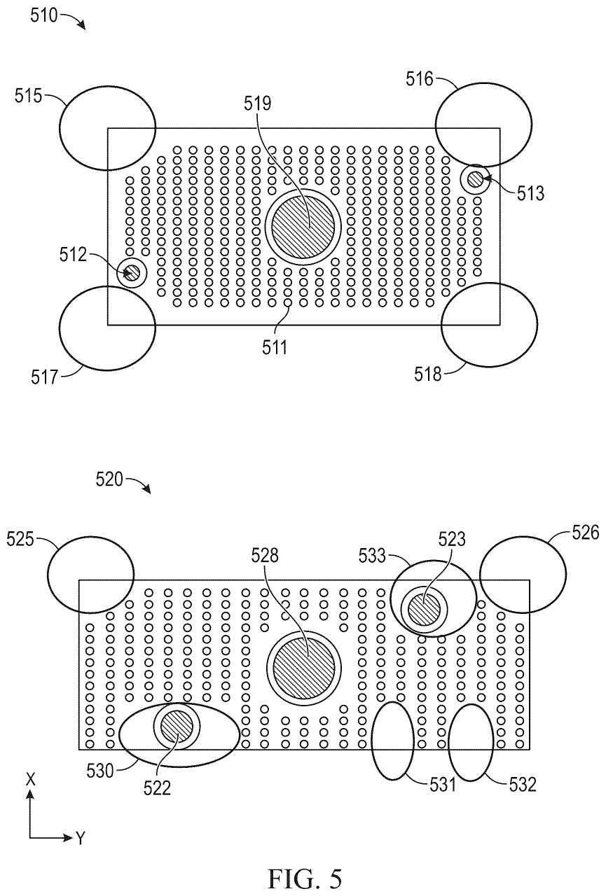

The first array 213 and the second array 223 may be electrically coupled together using a bridge board (e.g., as in FIG. 4), which has corresponding arrays of surface contact connections and provides conductive traces 230 to carry signals, data, and/or power between the arrays 213 and 223. In this example, the conductive traces 230 may allow for electrical communication between electronic component 211 and electronic component 221.

In one example, IHS 200 may implement host processors 101, chipset 102, system memory 103, a chip including bios 107 as mounted electronic components on board 210. In such an example, board 210 may be referred to as a main board or a motherboard. In one example, the processors 101 and chipset 102 may be implemented as an SoC, which is mounted on the board 210. The SOC may include any appropriate processor, such as a Central processing unit (CPU), a graphics processing unit (GPU), a reduced instruction set computer (RISC), and/or the like. Continuing with the example, IHS 200 may implement hard drive 113, communication interfaces 105 (e.g., input-output components), and USB ports 108 (e.g., another type of input-output components)as mounted electronic components on board 220. Of course, the scope of implementations may include any appropriate arrangement of various components on one or more circuit boards, and FIG. 2 shows one example.

FIG. 3 is an illustration of an example system 300, adapted according to some embodiments. System 300 illustrates a circuit board 301, which includes a conductive trace 306. Conductive trace 306 may include copper or other appropriate conductor, which is interleaved between two layers of insulative material of the circuit board 301.

Surface contact connection 302 is disposed upon the surface of circuit board 301. Surface contact connection 302 may include any appropriate structure, such as a solder ball or conductive pad. Furthermore, surface contact connection 302 may include any appropriate conductive material, such as a conductive alloy of silver. Surface contact connection 302 is formed upon the surface of circuit board 301 so that surface contact connection 302 is in physical and electrical contact with via 304. Via 304 may include a conductive material, such as a conductive alloy, formed within a hole that spans one or multiple layers of circuit board 301 and is physically and electrically in contact with conductor 306. Thus, surface contact connection 302 is electrically coupled to conductor 306.

In one example, surface contact connection 302 may include one of many surface contact connections within an array of surface contact connections. Furthermore, surface contact connection 302 may be further physically and electrically coupled to an electronic component.

Surface contact connection 303 is disposed upon the surface of circuit board 301 and may include any appropriate structure, such as a solder ball or conductive pad. Surface contact connection 303 may be formed in the same as or similar to surface contact connection 302. Also, via 305 may be formed the same as or similar to via 304. Via 304 provides electrical coupling between surface contact connection 303 and conductive trace 306. As shown in FIG. 3, surface contact connection 303 and surface contact connection 302 are in electrical communication with each other by virtue of vias 304, 305 and conductive trace 306.

System 300 is illustrated simply and shows only a single electrical coupling between two surface contact connections 302, 303. However, it is understood that the scope of implementations may include a multitude of different surface contact connections, each corresponding to a via and each being electrically coupled to one or more conductive traces.

Surface contact connection 303 may be one surface contact connection of many surface contact connections within an array of surface contact connections that are in electrical contact with multiple conductive traces. In one example, the surface contact connection 303 may be part of an array of surface contact connections, such as those described with respect to FIGS. 2 and 5-10. For instance, surface contact connection 302 may correspond to a pin connection of electronic component 211, and surface contact connection 303 may correspond to one of the surface contact connections within array 213. Similarly, surface contact connection 302 may correspond to a connection of electronic component 221, and surface contact connection 303 may correspond to one of the surface contact connections within array 223.

FIG. 4 is an illustration of example system 400, adapted according to some embodiments. System 400 includes a first circuit board 410, a second circuit board 420, and a third circuit board 430. Circuit board 410 is physically and electrically coupled to circuit board 430 by board connector 411. Similarly, circuit board 420 is physically and electrically coupled to circuit board 430 by board connector 421.

In the present example, circuit board 410 may correspond to circuit board 210 of FIG. 2, and circuit board 420 may correspond to circuit board 220 of FIG. 2. The circuit board 430 (e.g., a bridge board) may correspond to the un-illustrated board in FIG. 2 that provides conductive traces 230. Circuit board 430 may be implemented similarly to either of boards 210 or 220 of FIG. 2. That is, circuit board 430 may include multiple layers of insulative material having interleaved conductors therein.

Board connector 411 may include a first array of surface contact connections, which is implemented on the top surface of board 410 and may further include a second array of surface contact connections, which is implemented on the bottom surface of board 430. In such an example, each surface contact connection within the array on board 410 would correspond to another surface contact connection within the array on board 430 within board connector 411.

The first and second arrays of surface contact connections may be held together using any appropriate method, such as soldering, compression, and/or the like. In a compression example, boards 410 and 430 may provide a hole (not shown) for a fastener 412 to be inserted and tightened make a compression coupling. Similarly, boards 410 and 420 may also include a hole (not shown) for a fastener 422 to be inserted and tightened to make a compression coupling. An example of a fastener may include a screw or other appropriate item. The scope of implementation may also include different types of fastening within the same board connector system. For instance, boards 430 and 410 may be compression coupled using fastener 412, while boards 430 and 420 may use soldering or some other coupling technique.

Board connector 421 may be implemented similarly to board connector 411. Thus, board connectors 411 and 421, as well as board 430, may provide conduction of signals, data, and/or power between boards 410 and 420.

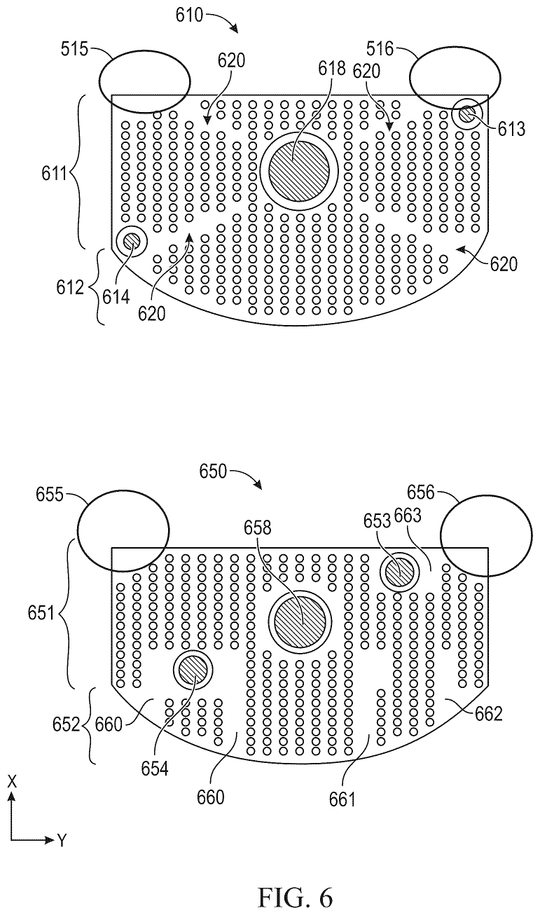

FIG. 5 is an illustration of arrays 510, 520 of surface contact connections, according to various embodiments. Arrays 510 and 520 are illustrations of different arrays that may be implemented as array 213 (or 223) of FIG. 2. Furthermore, arrays 510 and 520 are illustrations of different arrays that may be implemented within board connectors 411 and 421 of FIG. 4.

Array 510 of surface contact connections includes a multitude of individual surface contact connections in rows and columns, where rows correspond to being laid out in the Y dimension, and columns correspond to being laid out in the X dimension. One example surface contact connection is illustrated as surface contact connection 511.

In the X-Y plane, array 510 is in the shape of a chamfered rectangle. The shape is approximately rectangular with the corners cut off. In the example of array 510, the corners being cut off includes the corners 515-518 omitting surface contact connections. In some embodiments, the omission of surface contact connections in the corners 515-518 may aid in routing, such as by leaving the corners 515-518 less crowded of vias so that conductive traces may be laid within and through the corners. For the case of compression contacts within arrays 510 or 520, the same omission may aid management of mechanical compression forces, as the connector is fixed at hole 519 and 528 and the compression forces are known to decrease by distance from this center point.

Array 510 further includes a hole 519, which is a mounting opening to accommodate a fastener (e.g., 412). The hole 519 may omit having any surface contact connections and may include a hole through the material of the circuit board, such as through multiple layers of insulation. In this example, the hole 519 is surrounded by surface contact connections of the array 510. Thus, around the entire circle of hole 519, the hole 519 is adjacent to at least one surface contact connection. Furthermore, in the example of array 510, the hole 519 is approximately centered within the array 510 in the X-Y plane. The purpose of centering hole 519 is to ensure that compressive forces, attributable to the fastener, spread throughout the entirety of the array 510.

Array 510 further includes alignment holes 512, 513, which are placed at edges of the array 510. The alignment holes 512, 513 may accommodate alignment posts so that a board on which array 510 is implemented may be aligned with another board (e.g., board 430) during assembly to ensure that the individual surface contact connections of array 510 align and make adequate contact with individual surface contact connections (not shown) of a corresponding array on another board (e.g., board 430).

Array 520 is another implementation, having multiple rows and columns of surface contact connections. Array 520 includes corners 525, 526, which omit any surface contact connections and, thus, produce an overall chamfered rectangular shape of array 520 in the X-Y plane. Array 520 further includes hole 528 to accommodate a fastener in alignment holes 522, 523. In this example, hole 528 is a mounting opening that is formed roughly in the center of array 520 and is surrounded by surface contact connections.

Array 520 further includes portions 530-533 that omit any surface contact connections. A portion 530 includes alignment hole 522, and portion 533 includes alignment hole 523. The portions 530-533 may facilitate routing of traces by alleviating crowding due to vias. Portions 531-533, by virtue of omitting surface contact connections, may cause some of the columns to be half empty or more than half empty (e.g., only partially populated) of surface contact connections.

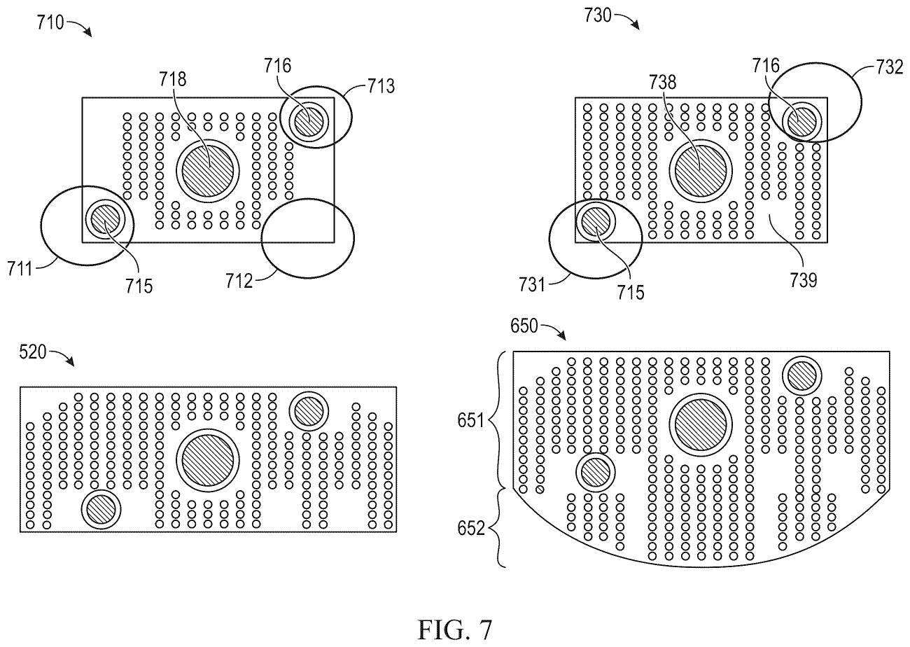

FIG. 6 is an illustration of example arrays 610, 650 of surface contact connections, according to various embodiments. The arrays 610, 650 may be used to implement the arrays of FIG. 2 and may be used to implement arrays used along with a board connector, such as illustrated in FIG. 4.

Array 610 includes a rectangular array portion 611 and a convex array portion 612. The convex portion 612 is placed adjacent the rectangular array portion 611 so that columns of surface contact connections in convex array portion 612 are aligned with columns of the rectangular array portion 611. The convex array portion 612 is positioned along a longest dimension (Y-dimension in this example) of the rectangular array portion 611. The rectangular array portion 611 in this example includes hole 618 to accommodate a fastener, and the hole 618 is approximately centered within the rectangular portion 611 and is surrounded by surface contact connections. Array 610 further includes alignment holes 613, 614.

The rectangular array portion 611 is generally shaped as a chamfered rectangle, with corners 615, 616 omitting any surface contact connections. Array 610 further includes a portion 620, which omits surface contact connections. Portion 620 is shaped as an X, and in the X-Y plane, it is approximately centered at holes 618. Portion 620, as well as corners 515, 516 may support routing of conductive traces.

Array 650 also includes a rectangular portion 651 and a convex portion 652, aligned to share columns of surface contact connections. The rectangular portion 651 is generally shaped as a rectangle having chamfered corners 655, 656, where the corner 655, 656 omits surface contact connections. Array 650 further includes hole 658 to accommodate a fastener as well as alignment holes 653, 654.

Array 650 further includes portions 660-663, which omit surface contact connections for purposes of routing. Portions 660-663 are not X-shaped, as with array 610. Rather, portions 660-663 are irregularly shaped and determined through use of design tools to determine convenient and efficient paths for routing conductive traces. Each of portions 660-663 omit surface contact connections to cause at least one column to be half empty or more than half empty.

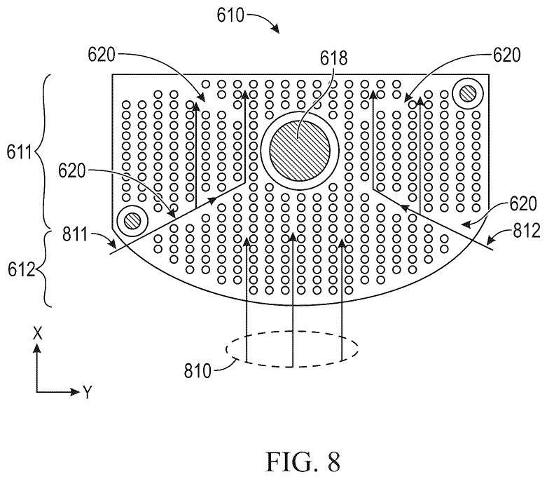

FIG. 7 shows example arrays 710, 730, 520, 650 of surface contact connections, according to some examples, to illustrate a size progression. Embodiments may be adapted for a given implementation by scaling to include more or fewer surface contact connections in a given array. For instance, array 710 illustrates an array that is smaller than array 730, which is smaller than array 520, which is smaller than array 650. In this example, array 650 scales array 520 by adding the convex portion 652. Any of arrays 710, 730, 520, 650 may be used to implement the arrays of FIG. 2 and may be used implement arrays used along with a board connector, such as illustrated in FIG. 4.

Array 710 is generally shaped as a rectangle with chamfered corners 711-713. Specifically, corners 711-713 omit any surface contact connections. Hole 718 is provided to accommodate a fastener, and it is approximately centered within array 710 and is surrounded by surface contact connections. Array 710 further includes alignment holes 716, 711.

Array 730 is generally shaped as a rectangle with chamfered corners 731, 732, which omit any surface contact connections. Hole 738 may accommodate a fastener. Hole 738 is arranged approximately in the center of array 730 and is surrounded by surface contact connections. Array 730 further includes alignment holes 715 and 716.

Portion 739 omits any surface contact connections. Portion 739, as well as chamfered corners 731, 732 may facilitate routing of conductive traces within array 730 due to lack of vias.

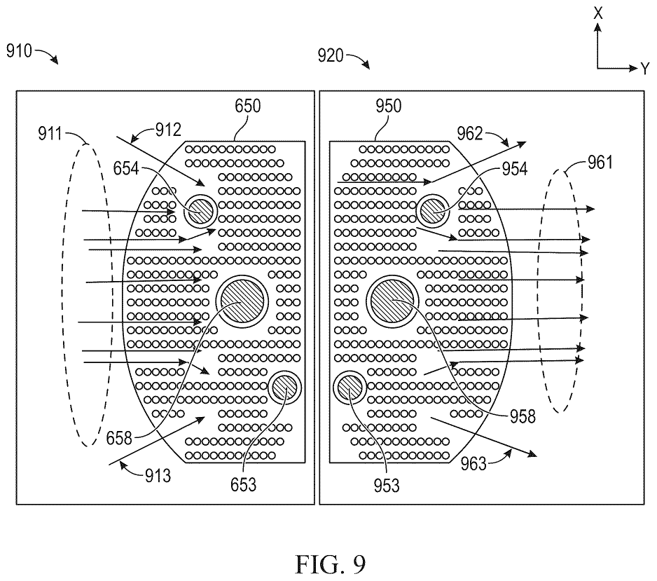

FIG. 8 is another illustration of example array 610, according to some embodiments. As noted above, array 610 includes portion 620, which is generally shaped as an X, and portion 620 omits any surface contact connections. FIG. 8 is provided to show how trace routing may be accomplished in array 610. While FIG. 8 focuses on array 610, it is understood that the principles described here may be adapted for use in other arrays as well.

Paths 810 are in the X-direction, and paths 810 go between the columns within the convex portion 612. While only three paths are shown as paths 810, it is understood that each of the columns in the convex portion 612 may correspond to one or more paths in the X-direction. Each of the paths 810 represents a channel in which a conductive trace may be routed to make electrical and physical contact with one or more surface contact connections (and corresponding vias). Each of the paths 810 may include trace routing on one or more layers of the accompanying circuit board.

In some embodiments, the routing supported by paths 810 may extend in the X-direction from the bottom of the array 610 to the top of the array 610 and may end in the X-direction around the hole 618. More specifically, in some embodiments, the density of surface contact connections within array 610 may practically only allow for paths 810 to support routing up to about the bottom (in the X-direction) of the hole 618.

The portion 620, which omits any surface contact connections and generally has an X-shape may support further paths 811, 812. Paths 811, 812 are generally diagonal in the X-Y plane and are defined by the shape of the portion 620. Paths 811, 812 may support trace routing in one or more layers of the accompanying circuit board. Furthermore, traces that follow the diagonal paths 811, 812 may then turn and follow the X-direction along the columns to provide trace routing to reach all or approximately all of the surface contact connections within array 610.

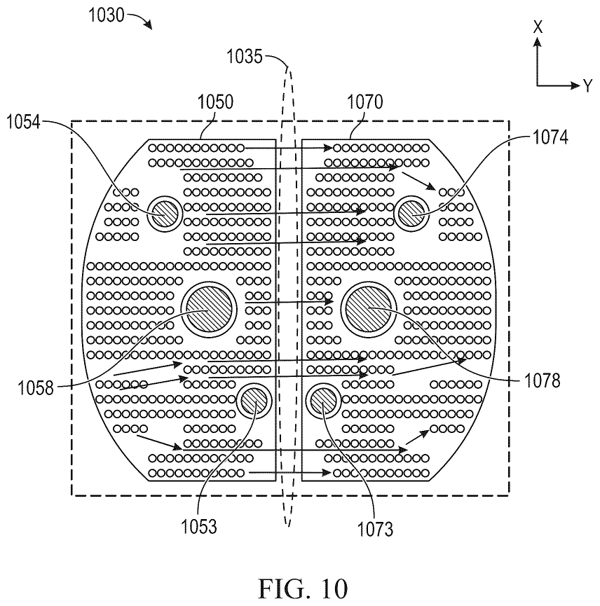

FIGS. 9-10 illustrate a board connecting system, including circuit boards 910 and 920, such as may correspond to boards 210 and 220 of FIG. 2 and boards 410 and 420 of FIG. 4, according to some embodiments. Board 1030 (FIG. 10) may correspond to board 430 of FIG. 4, according to some embodiments.

Board 910 and board 920 may both be circuit boards, having multiple layers of insulating material with interleaved conductive traces, where an example of a conductive trace is discussed above with respect to FIG. 3. Array 650 may be implemented on board 910, and array 650 may include surface contact connections, each of which may be electrically coupled to one or more of the conductive traces within board 910.

Paths 911-913 illustrate example channels in which conductive traces may be routed from circuit board 910 to the individual surface contact connections within array 650. As noted above, array 650 may include portions 660-663 (illustrated in FIG. 6), which may omit surface contact connections, thereby allowing for a higher density of traces within the circuit board layers corresponding to the areas underneath portions 660-663. Paths 911-913 illustrate example channels, and it is understood that as many channels may be used as is appropriate to provide electrical communication for all or nearly all of the individual surface contact connections.

Array 950 is implemented on board 920. Array 950 is mirrored and symmetrical with respect to array 650. In other words, array 950 and array 650 are symmetrical about a line in the X-dimension equidistant between alignment holes 653 and 953. Paths 961-963 illustrates example channels in which conductive traces may be routed from circuit board 950 to the individual ones of the surface contact connections of array 950. Paths 961-963 illustrate example channels, and it is understood that as many channels may be used as is appropriate to provide electrical communication for all or nearly all of the individual surface contact connections of array 950.

Array 950 further includes hole 958 to accommodate a fastener. Array 950 also includes alignment holes 953, 954.

Circuit board 1030 may correspond to a bridge board, such as board 430 of FIG. 4. FIG. 9 provides a top-down view of boards 910 and 920, with arrays 650, 950 implemented on top of the boards 910, 920 in the Z-direction. By contrast, FIG. 10 provides a top-down view looking through circuit board 1030, where arrays 1050, 1070 are implemented on the bottom of circuit board 1030 in the Z-direction. Thus, circuit board 1030 may be arranged so that array 1050 corresponds to array 650, and array 1070 corresponds to array 950 to make electrical contact between those arrays.

Array 1050 is approximately the same as array 650, though it is implemented upon board 1030. When circuit board 1030 is mounted to circuit board 910, alignment hole 654 may line with alignment hole 1054, and alignment hole 653 may align with alignment hole 1053. A fastener (not shown) may be inserted through both of holes 658 and 1058 to provide a compression connection. When aligned in this way, each of the individual surface contact connections of array 650 may have physical and electrical contact with a respective one of the individual surface contact connections of array 1050.

Array 1070 is approximately the same as array 950, though it is implemented on circuit board 1030. When circuit board 1030 is mounted on circuit board 920, alignment hole 954 may align with alignment hole 1074, and alignment hole 953 may align with alignment hole 1073. A fastener (not shown) may be inserted through both of holes 958 and 1078 to provide a compression connection. When aligned in this way, each of the individual surface contact connections of array 950 may have physical and electrical contact with a respective one of the individual surface contact connections of array 1070.

Furthermore, within circuit board 1030, there are routing paths 1035. The routing paths 1035 may include conductive traces within one or more layers of circuit board 1030, and each one of the individual surface contact connections within array 1050 may be electrically coupled with a respective individual surface contact connection within array 1070. Thus, when assembled and with compression connections between circuit boards 910 and 1030 and 920 and 1030, and electronic component (not shown) on circuit board 910 may be in electrical communication with another electronic component (not shown) on circuit board 920 by virtue of the arrays 650, 950, 1050, and 1070. Such principles are described above with respect to FIG. 1 and FIG. 4.

Of note in FIGS. 9-10, the paths 911-913, 961-963, and 1035 are shown as being unidirectional, though it is understood that individual conductive traces may be used for unidirectional or bidirectional communication of signals, data, and/or power. Additionally, while FIGS. 9-10 utilize a board system according to array 650, it is understood that the other arrays described herein may be adapted for use in a similar board system. Also, circuit board 1030 may be implemented as a relatively rigid board or may be implemented as a flexible board as appropriate.

Various embodiments described herein may provide advantages over other systems. For instance, the chamfered rectangular shapes of the arrays described herein may provide for improved contact in a compression contact scenario. For instance, in an example in which array 650 is in compression contact with array 1050, it would generally be expected that compression is greatest near the fasteners through holes 658 and 1058, and that compression force would be expected to decrease moving away from the holes 658, 1058. The chamfered corners (e.g., 655, 656 of FIG. 6) omit surface contact connections that would be expected to have the least amount of compression force, thereby avoiding intermittent electrical coupling at those corners that might otherwise occur if such corners were populated with surface contact connections. Intermittent electrical coupling may be caused by warpage of the mated circuit boards as compression forces press the circuit boards apart. The approaches described herein may allow the greatest number of reliable connections from the holes and may avoid addition of more holes to enlarge the array.

Furthermore, the concave portions (e.g., 612, 652 of FIG. 6) spread out from a mounting hole (e.g., 618, 658) approximately in a semicircle. The concave portions may add to a quantity of surface contact connections for an array while avoiding right-angle corners that might otherwise experience intermittent electrical connections due to weak compression force.

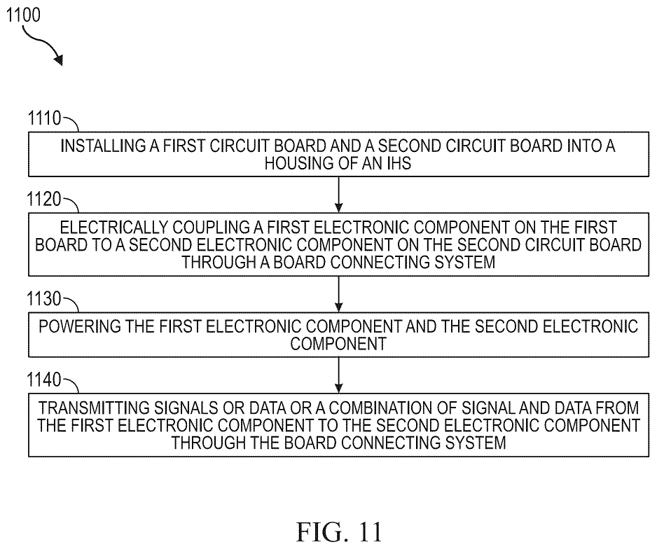

FIG. 11 is an illustration of an example method 1100, according to some embodiments, for manufacturing an IHS. Method 1100 may be performed by a manufacturer of an IHS to manufacture, e.g., IHS 200 of FIG. 2.

Action 1110 includes installing a first circuit board and a second circuit board into a housing of an IHS. In one example, the first circuit board may correspond to circuit board 210 of FIG. 2, and the second circuit board may correspond to circuit board 220. An example housing includes housing 201.

Action 1120 includes electrically coupling a first electronic component on the first circuit board to a second electronic component on the circuit board through a board connecting system. Electrically coupling a component on a first circuit board to a component on a second circuit board is described with respect to FIGS. 4, 9, and 10. For instance, the first circuit board may include a multitude of conductive traces that electrically couple to the first electronic component, and the second circuit board may include a multitude of conductive traces that electrically couple to the second electronic component. Furthermore, the first circuit board may include an array of surface contact connections, each of which is coupled to one or more of the conductive traces in the first circuit board. Similarly, the second circuit board may include an array of surface contact connections, each of which is coupled to one or more of the conductive traces in the second circuit board. The board connecting system may further include a third board (e.g., circuit board 430 or circuit board 1030) having matching arrays to provide electrical coupling from the first array to the second array.

Action 1130 includes powering the first electronic component and the second electronic component. For instance, during manufacture, there may be a testing or boot up phase, in which power is provided to provide full or partial operation for the first electronic component and the second electronic component.

Action 1140 includes transmitting signals or data or a combination of signals and data from the first electronic component to the second electronic component through the board connecting system. In the examples above, the first electronic component 211 of FIG. 2 may transmit signals or data or a combination thereof to the electronic component 221 through arrays 213 and 223 and through conductive traces 230. Similarly, the explanation of FIGS. 9-10 illustrate using a third board (e.g., circuit board 1030) to provide electrical communication between circuit boards 910 and 920.

Examples of transmitting signals may include transmitting analog signals, examples of transmitting data may include transmitting information represented by discrete digital signal levels. Furthermore, the board connecting system may also carry power and provide one or more electrical coupling paths for provision of power between circuit boards.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of ML/AI software. These program instructions may also be stored in a computer readable storage medium that can direct a computer system, other programmable data processing apparatus, controller, or other device to operate in a particular manner, such that the instructions stored in the computer-readable medium produce an article of manufacture including instructions which implement the operations specified in the block diagram block or blocks.

Program instructions may also be loaded onto a computer, other programmable data processing apparatus, controller, or other device to cause a series of operations to be performed on the computer, or other programmable apparatus or devices, to produce a computer-implemented process such that the instructions upon execution provide processes for implementing the operations specified in the block diagram block or blocks.

Modules implemented in software for execution by various types of processors may, for instance, include one or more physical or logical blocks of computer instructions, which may, for instance, be organized as an object or procedure. Nevertheless, the executables of an identified module need not be physically located together but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices.

Similarly, operational data may be identified and illustrated herein within modules and may be embodied in any suitable form and organized within any suitable type of data structure. Operational data may be collected as a single data set or may be distributed over different locations including over different storage devices.

Reference is made herein to “configuring” a device or a device “configured to” perform some operation(s). It should be understood that this may include selecting predefined logic blocks and logically associating them. It may also include programming computer software-based logic of a retrofit control device, wiring discrete hardware components, or a combination of thereof. Such configured devices are physically designed to perform the specified operation(s).

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs.

As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

1. An information handling system (IHS) comprising:
a first circuit board having a first electronic component disposed thereon;
a second circuit board having a second electronic component disposed thereon; and
a board connecting system providing electrical coupling from the first circuit board to the second circuit board, including providing electrical communication between the first electronic component and the second electronic component, wherein the board connecting system includes a first array of surface contact connections on the first circuit board, wherein the first array of surface contact connections has a first portion arranged as a chamfered rectangular shape and a mounting opening surrounded by a first set of the surface contact connections.

2. The IHS of claim 1, wherein the first array of surface contact connections further includes a convex portion having a second set of the surface contact connections, wherein the convex portion is arranged along a longest dimension of the chamfered rectangular shape.

3. The IHS of claim 1, wherein the first array of surface contact connections includes an X-shaped portion, centered on the mounting opening, wherein the X-shaped portion omits surface contact connections.

4. The IHS of claim 3, wherein the X-shaped portion includes a plurality of conductors within channels defined by the X-shaped portion.

5. The IHS of claim 1, wherein the first array of surface contact connections includes a plurality of rows and a plurality of columns, wherein a first column of the plurality of columns is partially populated with surface contact connections.

6. The IHS of claim 5, wherein the first column includes a plurality of conductors within a channel defined by a partially populated portion of the first column.

7. The IHS of claim 1, wherein the board connecting system further comprises:
a second array of surface contact connections on the second circuit board, wherein the second array of surface contact connections is arranged symmetrically with respect to the first array of surface contact connections.

8. The IHS of claim 7, wherein the board connecting system further comprises:
a third board having third and fourth arrays of surface contact connections, the third board being disposed upon the first board and the second board, further wherein the third array of surface contact connections is in electrical contact with the first array of surface contact connections, and wherein the fourth array of surface contact connections is in electrical contact with the second array of surface contact connections, further wherein the third board has a plurality of conductors, providing the electrical communication between the first electronic component and the second electronic component.

9. The IHS of claim 8, wherein the board connecting system further comprises:
a first fastener, disposed within the mounting opening and providing compression between the first array of surface contact connections and the third array of surface contact connections; and
a second fastener, disposed within a mounting opening of the second array of surface contact connections, the second fastener providing compression between the second array of surface contact connections and the fourth array of surface contact connections.

10. The IHS of claim 1, wherein the IHS comprises a laptop computer, and wherein the first electronic component comprises a processor, and wherein the second electronic component comprises an input-output component.

11. An information handling system (IHS) comprising:
a system on-chip (SoC);
a first circuit board, upon which the SoC is disposed; and
a board connector arranged at a first edge of the first circuit board, wherein the board connector comprises a first array of surface contact connections, each surface contact connection of the first array being electrically coupled to a respective conductor within the first circuit board, further wherein the first array of surface contact connections has a first portion that is a chamfered rectangular shape and a second portion that is a convex shape and adjacent the first portion, further wherein the first array includes a mounting hole that is surrounded by a subset of the surface contact connections.

12. The IHS of claim 11, wherein the SoC includes a plurality of pins that are in electrical communication with at least a subset of the respective conductors within the first circuit board and with at least a subset of the surface contact connections of the first array.

13. The IHS of claim 11, wherein the first array of surface contact connections includes an X-shaped portion, centered on the mounting opening, wherein the X-shaped portion omits surface contact connections.

14. The IHS of claim 13, wherein the X-shaped portion includes a plurality of the conductors within channels defined by the X-shaped portion.

15. The IHS of claim 11, wherein the first array of surface contact connections includes a plurality of areas omitting the surface contact connections, wherein each of the plurality of areas defines a respective channel for the conductors within the first circuit board.

16. The IHS of claim 11, further comprising:
a second circuit board, upon which an electronic component is disposed;
a second array of surface contact connections, arranged at an edge of the second circuit board and electrically coupled with the electronic component, wherein the second array of surface contact connections is symmetrical to the first array of surface contact connections; and
a bridge board, electrically coupling the first array of surface contact connections to the second array of surface contact connections.

17. A method comprising:
installing a first circuit board and a second circuit board into a housing of an information handling system (IHS); and
electrically coupling a first electronic component of the IHS to a second electronic component of the IHS by coupling the first circuit board, having the first electronic component, to the second circuit board, having the second electronic component using a board connecting system,
wherein the board connecting system includes a first array of surface contact connections on the first circuit board, wherein the first array of surface contact connections has a first portion arranged as a chamfered rectangular shape and a mounting opening surrounded by a first set of the surface contact connections.

18. The method of claim 17, wherein the board connecting system includes a second array of surface contact connections on the second circuit board, wherein the second array of surface contact connections is mirrored and symmetrical with respect to the first array, further wherein the board connecting system includes a third board electrically coupling the first array to the second array.

19. The method of claim 18, further comprising:
applying power to the first electronic component and to the second electronic component.

20. The method of claim 18, further comprising:
transmitting signals or data or a combination of signals and data from the first electronic component to the second electronic component through the board connecting system.
